(19) United States
(12) Patent Application Publication
(10) Pub. No.: US 2001/0015833 A1
(43) Pub. Date: Aug. 23, 2001

(54) Method for data transmission

(76) Inventor: Erwin Koller, Horgen (CH)

Correspondence Address: BURNS DOANE SWECKER & MATHIS L L P, POST OFFICE BOX 1404, ALEXANDRIA, VA, 22313-1404, US

(21) Appl. No.: 09/782,254

(22) Filed: Feb. 14, 2001

(30) Foreign Application Priority Data
Feb. 21, 2000 (DE) 100 07 823.0

(51) Int. Cl. H04N 1/04

(52) U.S. Cl. 358/484; 358/409

(57) ABSTRACT

The present invention relates to a method for transmitting binary data at a rate of R bits per second via an optical conductor of length d. A transmitter produces pulses of duration τ, which is considerably shorter than the bit period 1/R associated with the rate R. Owing to the dispersive characteristics of the optical conductor, these pulses are broadened on their path to the receiver to a value which is approximately equal to the bit period 1/R. One advantage is that there is no a priori need to use a laser with a narrow spectral width to achieve a long transmission distance d.

The present invention relates to the field of communication over long distances by means of optical conductors. It relates to a method for data transmission as claimed in the precharacterizing clause of patent claim 1.

Chapter 71.2 “Long Distance Fiber Optic Communications” in the “Electrical Engineering Handbook” (Edited by R. Dorf, CRC Press LLC, 1999, pages 1584-1591) contains an up-to-date overview of the field of fiber-optic telecommunications. The digital transmission of binary data by means of laser-generated light pulses in optical conductors is feasible without any problems at data rates of several 10 Mbps over distances of several tens of kilometers. Systems for fiber-optic data transmission comprise a transmitter having a light source (laser diode), an optical conductor (glass fiber cable) and a receiver with a light detector (photodiode). The attenuation of the optical pulses in the optical conductor restricts the maximum transmission distance, but at a light wavelength of 1550 nm, this attenuation is minimal.

The said systems are characterized by a so-called “bit rate-distance product” or “bandwidth-distance product” which means that a long transmission distance is correlated with a low maximum transmission rate (bandwidth) One reason for the decrease in the bandwidth of the optical conductor with its length is the dispersive characteristics of most glass fibers. In the single-mode fibers which are preferably used, the most important dispersion has a chromatic origin and is caused by wavelength-dependent refractive indices and propagation characteristics. A non-monochromatic light pulse from a source having a finite spectral width is in consequence broadened on its path through the optical conductor.

Such pulse broadening Δτ over an optical conductor length d is given by Δτ=M·d·Δλ. In this case, Δλ denotes the spectral width of the light source. The dispersion factor M of many of the single-mode fibers being laid today is approximately 18 picoseconds per nanometer of spectral width (Δλ) and per kilometer of fiber length (d) for wavelengths around 1550 nm.

With a transmission rate of R bits per second, either one pulse or no pulse is transmitted per bit, with a pulse width which is equal to the bit period 1/R. Pulse broadening Δλ of more than 50% of the original pulse width leads to interference in the receiver and transmission errors since, in this case, the broadened pulse extends excessively into the bit period of the next bit.

Increasing the transmission distance d while keeping the transmission rate R constant, that is to say a constant bit period and maximum tolerable pulse broadening, requires a reduction of the dispersion. This comprises firstly active compensation, for example by sections of the fiber being formed from optical conductors having a negative dispersion factor, or by the pulses being distorted deliberately by the transmitter in a specific manner. Secondly, it is also possible to use light sources which are more monochromatic, and are correspondingly more expensive, that is to say semiconductor lasers with a narrower spectral width.

The object of the present invention is to specify a method which makes it possible to increase the maximum transmission distance of a fiber-optic data transmission system, which is limited due to dispersive optical conductor effects. This object is achieved by a method having the features of patent claim 1.

The essence of the invention is to reduce the pulse with of the generated light pulses to a value which is shorter than the bit period associated with the selected rate. The dispersion-induced broadening of the pulse is not reduced, but is utilized to obtain pulses having a width which is approximately equal to the bit period at the receiver.

Thus, both the arriving light pulses and the pauses in-between them have the same time duration at the receiver. This allows the requirements for the receiver to be reduced. At the same time, this makes it possible to dispense with expensive lasers with a narrow spectral width.

In one preferred embodiment of the method according to the invention, a pulse sequence arriving at the receiver is in the form of an NRZ signal.

Further advantageous embodiments result from the dependent patent claims.

The invention will be explained in more detail in the following text with reference to exemplary embodiments and in conjunction with the drawings, in which:

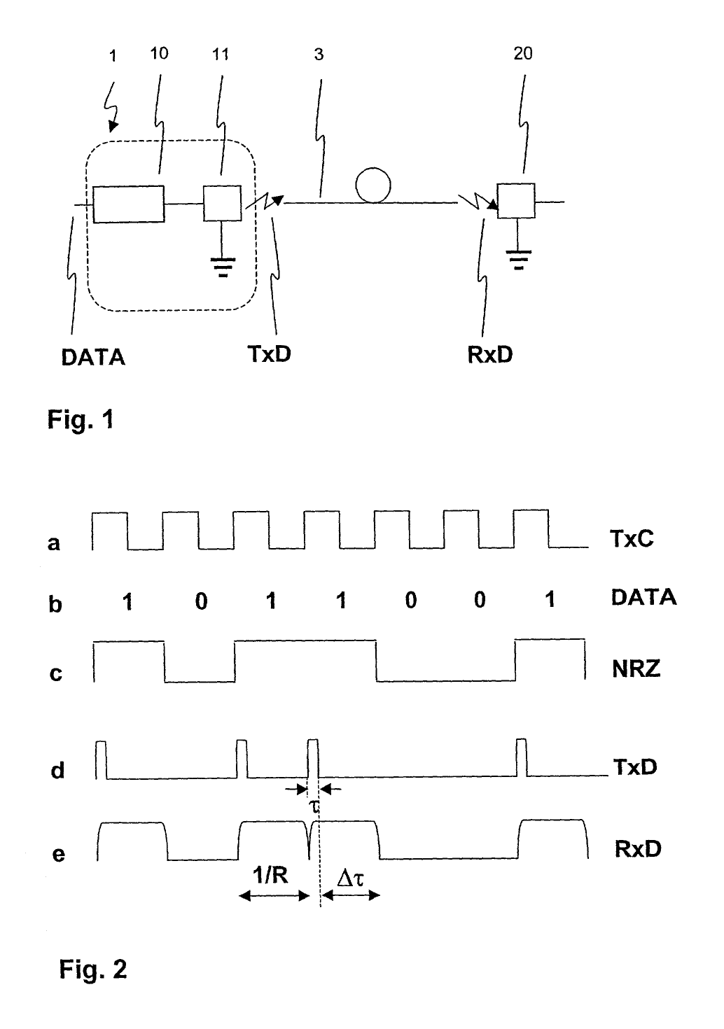

FIG. 1 shows a system for fiber-optic data transmission;

FIG. 2 shows signals of a bit sequence to be transmitted to various points in the system.

The reference symbols used in the drawing are summarized in the List of Reference Symbols. In principle, identical parts are provided with the same reference symbols.

FIG. 1 shows a system for fiber-optic data transmission, which comprises a transmitter 1, a receiver 2, and an optical conductor 3 of length d between the transmitter 1 and the receiver 2. The transmitter 1 has a modulator 10 and a light source 11, preferably a laser diode, which is actuated by the modulator 10 and generates light pulses. The latter are passed through the optical conductor 3 to the receiver 2, where they are detected by a light detector 20, preferably a photodiode. The detector is normally followed by an amplifier, which is not shown in FIG. 1. The optical conductor 3 is, for example, a glass-fiber cable and has certain dispersive characteristics, which are characterized by a dispersion factor M.

On a time axis, FIG. 2 shows the form assumed by a bit sequence to be transmitted, and results, for example, from pulse code modulation (PCM) at the points (DATA, TxD, RxD) identified in a corresponding manner in FIG. 1. Line a) shows the transmitter clock (TxC) and line b) shows any desired logic signal (DATA) defined as a sequence of “1” or “0” bits. This bit sequence (DATA) may be represented physically, for example, as an NRZ signal (non-return-to-zero), that is to say in the NRZ pulse modulation format for binary data (line c). In the NRZ format, the modulated variable of a carrier wave, that is to say the amplitude, for example, in intensity modulation (on-off keying), experiences no change between two immediately successive “1” or “0” bits.

Actuated by the pulse modulator 10, the laser diode 11 generates, for example, an optical pulse of width τ of each “1” bit. The corresponding transmission pulse sequence (transmitted data TxD) at the output of the transmitter is shown in line d). Each individual pulse is broadened on its path through the optical conductor 3 by the value Δτ. Line e) shows the received pulse sequence (received data RxD) detected at the receiver 2. Said received pulse sequence is preferably at least approximately in the form of the NRZ signal which is illustrated at c) and is associated with the bit sequence b).

In the present description, the term “pulse width” means the time duration τ of a pulse and, correspondingly, “broadening” means lengthening in time. Depending on the form of the light pulses which are present, the pulse width can preferably be defined at half the magnitude of the pulse maximum. For a transmission rate of R bits per second (bps), the bit period, that is to say the duration of one bit, is 1/R seconds.

The laser diode 11 has a certain spectral width Δλ, that is to say no purely monochromatic light pulses are emitted, but pulses with wavelengths between λ and λ±Δλ/2. With the DFB (distributed feedback) type semiconductor laser diodes which are preferably used and which operate at data rates from 155 Mbps to 10 Gbps, the spectral width is typically 0.1 nm. However, this spectral width can be reduced to a few thousandths or millionths of a nanometer by using expensive, stabilized-temperature diodes.

The broadening Δτ, induced by the dispersion in the optical conductor 3, of a light pulse passing through it depends on the optical conductor length d in accordance with an already known relationship Δτ=M·d·Δλ. In contrast to this, signal broadening produced by the finite response times of the laser diode 11 and/or of the photodiode 20 is not dependent on the length d, and will be ignored in the following text. For the intended transmission distances of several hundred kilometers, the attenuation of the signals is not a limiting factor and, if necessary, could be compensated for by optical booster amplifiers, as well. With the high transmission rates R being aimed for, the range limitation is due to the optical conductor dispersion, via the “rate-length” product. In single-mode fibers and with a light wavelength λ of 1550 nm, the said dispersion factor M is approximately 18 ps/km/nm.

With known transmission methods, symmetrical pulses with a pulse duration equal to the bit period 1/R are generated by the transmitter, with a transmission rate R of, for example, 622 Mbps, that is to say with the duration of 1.6 ns. For the said values of M (18 ps/km/nm) and Δλ (0.1 nm), the maximum range due to optical conductor dispersion is approximately 500 km, since the broadening of a pulse with a greater line length exceeds half one bit period, and results in unacceptable interference in the receiver. Thus, if Δτ =1/2 R, the “rate-length product” is R·d=1/2·M·Δλ≈277 Gbit-km. If the transmission distance d is now increased with the rate R remaining constant, it is necessary to change to a laser having a narrower spectral width.

According to the invention, the use of lasers with a narrow spectral width is avoided, and the transmission pulse duration is reduced for instead. The modulator is used to select the width τ of a transmission pulse such that only the broadened pulse has approximately the duration of one bit period 1/R at the detector. Since the broadening Δτ depends on the transmission distance d, the modulator must know this distance in advance, as a parameter. For example, in the above example, it is possible to use a laser with a rate of 2.5 Gbps, which can generate pulses with a duration of 0.4 ns and with a spectral width of 0.1 nm. If pulses with a duration of one bit period arrive at the detector, up to 1.2 ns is thus available for pulse broadening Δτ, which results in the system range being increased by more than 150 km to 666 km. The “rate-length product” is thus 666 km×0.662 Gbps. This is more than 1.33 times the value obtained with conventional plotting (pulse width for the transmitter=bit period). A pulse width τ at the transmitter of 0.52 ns is selected, in a corresponding manner, for a transmission distance of 600 km. The method according to the invention can also, of course, be used for any other desired transmission rates R.

Although asynchronous operation of the method according to the invention is also feasible, the described method is suitable for use with SDH Standards (Synchronous Digital Hierarchy) for synchronous data transmission. The associated basic transmission rate STM-1 is 155.52 Mbps, and multiples of this are known as STN-4, −16 and −64. The method according to the invention is, furthermore, not limited to any specific coding scheme for synchronization (for example clock encoding or DPLL). The method, which has been explained above on the basis of an NRZ signal, can also be transferred in the same sense to other modulation forms.

The method according to the invention makes it possible to make the dispersion-dependent range limitation less severe. Further advantages result from the fact that lower-cost light sources (laser diodes) can be used. In addition, the ratio between arriving “1” bits and “0” bits at the detector is approximately equal to 1, as a result of which the requirements for receiver sensitivity are reduced, and savings are also possible in this area. The method according to the invention allows a Gbit Ethernet to be provided over long distances at an acceptable cost.

### LIST OF REFERENCE SYMBOLS

1 Transmitter

10 Modulator

11 Light source, laser diode

2 Receiver

20 Light detector, photodiode

3 Optical conductor

DATA Bit sequence

TxC Clock for the transmitter

TxD Pulse sequence at the transmitter

RxD Pulse sequence at the receiver

τ Transmission pulse width

Δτ Pulse broadening

R Transmission rate

d Transmission distance

1. A method for transmitting binary data at a rate of R bits per second via a dispersive optical conductor (3) of length d between a transmitter (1) and a receiver (2), where
a) the transmitter (1) comprises a light source (11) which produces optical pulses with a transmission pulse width τ,
b) the pulses are passed through the optical conductor (3) to the receiver (2) and in the process are broadened by a value Δτ as a consequence of the optical conductor (3) having a dispersive characteristic,
c) the receiver comprises a light detector, in which the optical pulses arrive with a reception pulse width τ+Δτ, characterized in that
d) the transmission pulse width τ is less than one bit period 1/R, and the reception pulse width τ+Δτ is approximately equal to one bit period 1/R.

2. The method as claimed in claim 1, characterized in that the transmission pulse width τ is selected as a function of the transmission distance d.

3. The method as claimed in claim 1, characterized in that a sequence of pulses at the receiver (2) at least approximately represents an NRZ signal.

4. The method as claimed in claim 1, characterized in that the distance d is more than 500 km.

5. The method as claimed in claim 1, characterized in that said method is used for synchronous data transmission.
